(19) United States
(12) Patent Application Publication
(10) Pub. No.: US 2024/0355196 A1
(43) Pub. Date: Oct. 24, 2024

(54) FLOW-AWARE DEMAND FORECAST METHODS AND SYSTEMS FOR MULTIMODE MOBILITY

(71) Applicant: HITACHI, Ltd., Tokyo (JP)

(72) Inventors: Ramyar SAEEDI, Santa Clara, CA (US); Malarvizhi SANKARANARAYANASAMY, Mountain View, CA (US); Rahul VISHWAKARMA, Berkeley, CA (US); Prasun SINGH, San Jose, CA (US); Shouchun PENG, San Jose, CA (US); Ravigopal VENNELAKANTI, San Jose, CA (US)

(21) Appl. No.: 18/137,928

(22) Filed: Apr. 21, 2023

(51) Int. Cl. G08G 1/01; G01C 21/32; G01S 19/42

(52) U.S. Cl. CPC G08G 1/0125; G01C 21/32; G01S 19/42

(57) ABSTRACT

A method for demand estimation. The method may include collecting people flow data from a network of a plurality of sensors within an area of interest, wherein each sensor of the plurality of sensors is associated with a user device; processing the people flow data to generate movement trajectories; mapping the movement trajectories to existing transportation network; aggregating the movement trajectories associated with the network of the plurality of sensors to estimate movement flow density; for the people flow data representing less than entire population of the area of interest, performing data simulation to rescale the movement flow density; classifying the people flow data into different transportation types; and generating flow-demand matching by matching current demand with transportation resource information.

### BACKGROUND

### Field

The present disclosure is generally directed to a method and a system demand estimation and, more specifically, to a method of transportation demand estimation based on people flow data.

### Related Art

The growing urban population and changes in travel patterns necessitate for ways to match supply with demand in urban areas. With the emergence of ride-hailing services and other new demand responsive modes of transportation, it is necessary to develop advanced analytic models capable of capturing detailed behavior of travelers and passengers.

In addition to demand estimation, it is also necessary to classify/segment demand to different modes of transportation, because traveler choices can significantly affect the performance of supply elements. Accurate demand estimation and segmentation ensure the applicability of a fair platform where different parties can cooperate to provide seamless and reliable services for users.

Furthermore, recent advances in sensors and mobile devices have enabled an unprecedented increase in the availability and collection of urban trajectory data, thus increasing the demand for more efficient ways to analyze data and manage cities and resources. Various modes of transportation differ in terms of their specification, usage, purpose, and data. It is needed to understand the difference and develop analytic models accordingly.

In the related art, demand forecast is utilized, which is largely based on historical data of demand for a specific mode of transportation. There are a number of limitations that relate to these methods. Specifically, the demand forecast is only based on historical data, and thus doesn't consider the dynamic nature of cities, people behavior, and latent demand. Second, the methods have been developed in silo-mode for different parties and cannot capture potential demand shift between different modes of transportation. While focusing on a single mode allows for simpler analysis of structural patterns and similarities among cities, it is insufficient for characterizing the transportation system as a whole. The methods also do not involve any detailed and real-time data collection and big data analytics, and is mostly based on years of survey data. Most importantly, the methods do not involve real people flow as part of the demand forecast.

In the related art, people flow analytics are applied to focus on local flow estimation and is mostly based on camera-based systems, which can be expensive and can't be applied to thoroughly cover data collection representing an entire area. This is mostly useful for local analytics and flow management of stations and other available resources. In addition to camera-based flow estimation, vehicle occupation sensors have been be used to collect ridership data on vehicles. Although, occupancy data is useful and provides insights in terms of demand estimation, it doesn't capture the dynamic interaction between different modes of transportation as well as latent demand.

In the related art, scenario simulation is used to model transportation systems. The goal of simulation is to come up with new plans, schedules, and allocation methods that consider changes in infrastructure, modes of transportation, population, points of interest, and new business models. These simulations are limited to high level planning, and is difficult to apply and run simulations for micro planning and daily forecasts.

### SUMMARY

Aspects of the present disclosure involve an innovative method for demand estimation. The method may include collecting people flow data from a network of a plurality of sensors within an area of interest, wherein each sensor of the plurality of sensors is associated with a user device; processing the people flow data to generate movement trajectories; mapping the movement trajectories to existing transportation network; aggregating the movement trajectories associated with the network of the plurality of sensors to estimate movement flow density; for the people flow data representing less than entire population of the area of interest, performing data simulation to rescale the movement flow density; classifying the people flow data into different transportation types; and generating flow-demand matching by matching current demand with transportation resource information.

Aspects of the present disclosure involve an innovative non-transitory computer readable medium, storing instructions for demand estimation. The instructions may include collecting people flow data from a network of a plurality of sensors within an area of interest, wherein each sensor of the plurality of sensors is associated with a user device; processing the people flow data to generate movement trajectories; mapping the movement trajectories to existing transportation network; aggregating the movement trajectories associated with the network of the plurality of sensors to estimate movement flow density; for the people flow data representing less than entire population of the area of interest, performing data simulation to rescale the movement flow density; classifying the people flow data into different transportation types; and generating flow-demand matching by matching current demand with transportation resource information.

Aspects of the present disclosure involve an innovative server system for demand estimation. The server system may include collecting people flow data from a network of a plurality of sensors within an area of interest, wherein each sensor of the plurality of sensors is associated with a user device; processing the people flow data to generate movement trajectories; mapping the movement trajectories to existing transportation network; aggregating the movement trajectories associated with the network of the plurality of sensors to estimate movement flow density; for the people flow data representing less than entire population of the area of interest, performing data simulation to rescale the movement flow density; classifying the people flow data into different transportation types; and generating flow-demand matching by matching current demand with transportation resource information.

Aspects of the present disclosure involve an innovative system for demand estimation. The system may include means for collecting people flow data from a network of a plurality of sensors within an area of interest, wherein each sensor of the plurality of sensors is associated with a user device; means for processing the people flow data to generate movement trajectories; means for mapping the movement trajectories to existing transportation network; means for aggregating the movement trajectories associated with the network of the plurality of sensors to estimate movement flow density; for the people flow data representing less than entire population of the area of interest, means for performing data simulation to rescale the movement flow density; means for classifying the people flow data into different transportation types; and means for generating flow-demand matching by matching current demand with transportation resource information.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example demand forecasting system for people flow data collection, in accordance with an example implementation.

FIG. 2 illustrates an example process flow for flow-aware demand forecasting utilizing the system, in accordance with an example implementation.

FIG. 3 illustrates an example sequential matching flow between GPS points and infrastructure, in accordance with an example implementation.

FIG. 4 illustrates an example hexagonal tessellation configuration showing movement across different regions, in accordance with an example implementation.

FIG. 5 illustrates an example process flow for transportation classification, in accordance with an example implementation.

FIG. 6 illustrates an example transportation mode flow that is divided based on segments, in accordance with an example implementation.

FIG. 7 illustrates an example process flow for the flow-demand matching step of FIG. 2, in accordance with an example implementation.

FIG. 8 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In the example implementations, city level flow and resources are utilized to enrich accurate demand estimation and segmentation model generation. Passenger people flow data is used to capture both real and latent demand that can be used to accurately plan for different spatial and temporal horizons (e.g., micro and macro level).

The demand forecasting system provides comprehensive view of total demand including historical demand, demand related to emerging services and technologies, and latent demand (e.g., unseen by the system due to lack of proper planning and inaccurate supply-demand matching). Such data have important applications in transportation research fields, for instance, to detect the movement mode of travelers, calculate traffic flow in an area, and predict the traffic flow at a certain time in the future.

People flow data can be used to capture the overall flow in city level and segment demand into different categories. The segmented demand can then be analyzed to perform demand-supply matching for different modes of transportation. Accurate demand can be used to revisit mobility plans and redesign cities accordingly in multiple spatial and temporal scales.

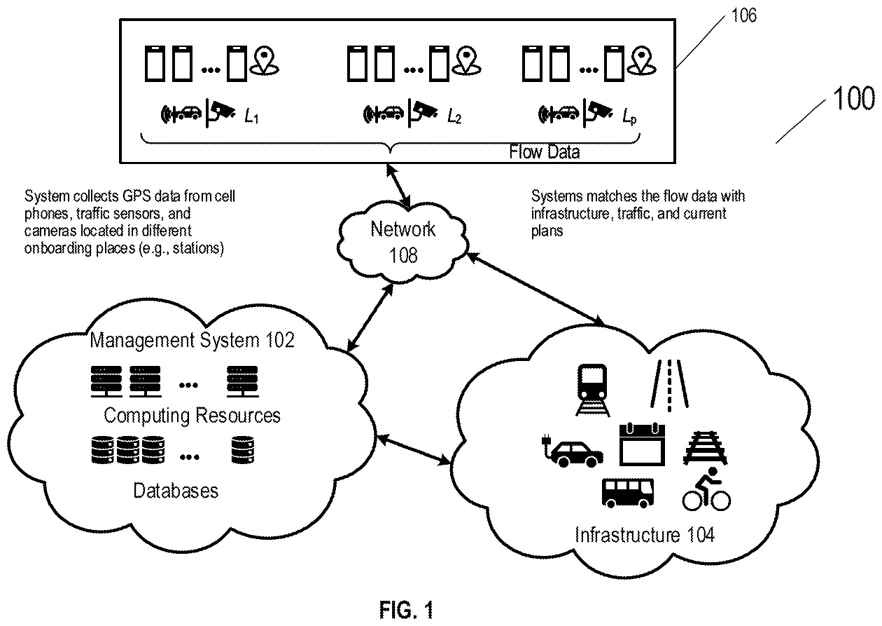

FIG. 1 illustrates an example demand forecasting system for people flow data collection, in accordance with an example implementation. As illustrated in FIG. 1, the demand forecasting system 100 collects people flow data from various information technology (IT) devices 106. The IT devices 106 may include, but not limited to, cells phones, traffic sensor, global positioning system (GPS), cameras located in onboarding locations such as stations, etc. In some example implementations, the people flow data comprises global positioning system (GPS) data. The system 100 may include management system 102, infrastructure 104, IT devices 106, and a network 108. The management system 102, infrastructure 104, and IT devices 106 are communicatively coupled to the network 108.

The collected people flow data are then stored at databases of management system 102 for subsequent mapping. Aggregation of cellular locations or calculation of cell tower usage densities can then be performed by computing resources of the management system 102 based on movement associated with or tracked by the IT devices at a macro level. For example, observation of pedestrians moving from one intersection to another. The system then matches the flow data with infrastructure information, traffic information, and existing transportation plans associated with infrastructure 104. The matched data can then be used to generate demand forecasting.

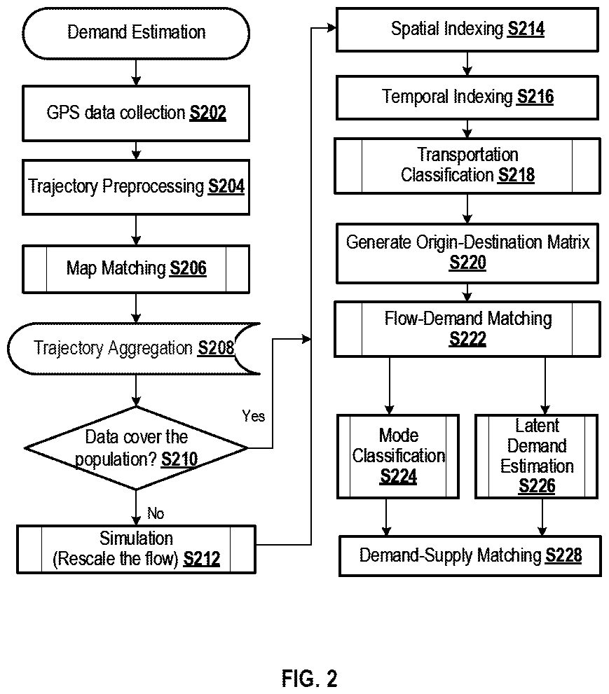

FIG. 2 illustrates an example process flow for flow-aware demand forecasting utilizing the system, in accordance with an example implementation. The process begins at S202, where people flow data over an area of study is collected. People flow data collection allows for collection of movement data in a specified area and matching the collected data with modes of transportation. At S204, trajectory preprocessing is performed over the collected people flow data. Trajectory preprocessing provides data cleaning and smoothing to address GPS system errors such as warm-cold start issues, urban canyon, etc. Step S204 helps to prepare meaningful samples that can be mapped into higher level of movement in a spatial scale such as zip code, city, etc. Trajectory preprocessing involves interpolation, filter, and removal of GPS samples.

At S206, map matching is then performed after trajectory preprocessing. Map matching matches recorded trajectories (people flow data) to a logical model of the real-world entities. Specifically, mapping dynamic behaviors of the people flow data as observed into edges of existing transportation network in a sorted list based on traveling device user or vehicle's time stamps.

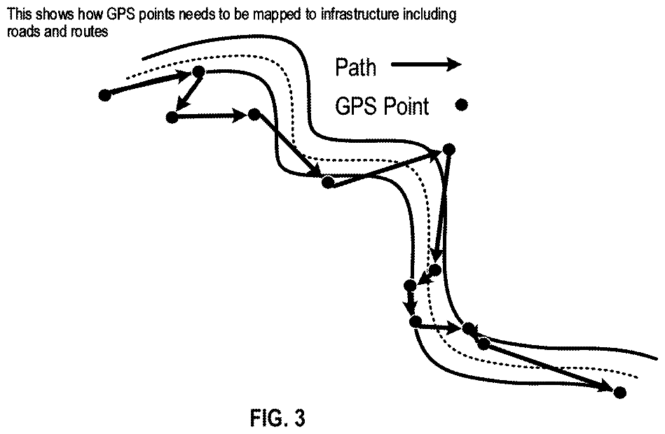

FIG. 3 illustrates an example sequential matching flow between GPS points and infrastructure, in accordance with an example implementation. As illustrated in FIG. 3, the points are observed GPS points and the arrows indicate movement paths between observed points. The trajectories of the GPS points are mapped into existing networks such as roads. In some example implementations, public transportation routes are used in conjunction with GPS points in map mapping. If the goal of map matching is to map movements between different zip code areas, then it is not necessary to require trajectory mapping to roads and routes as zip code mapping is more coarse-grained.

Referring back to FIG. 2, trajectory aggregation is then performed at S208. The mapped trajectories are mapped across spatial and temporal dimensions to generate snapshots of flow for different time steps. At S210, a determination is made as to whether the collected data represents the entire population. If the answer is yes, then the process proceeds to S214. If the answer is no at S210, then the process proceeds to S212, where a simulation is performed over the collected data to rescale the flow. In general, information collection from all users and vehicles representative of an entire population is typically impossible and thus, it becomes necessary to use available data, points of interest, survey data, traffic sensors, etc. to generate more realistic data flow and rescale it to represent the flow of an area. Simulation is performed to rescale the flow based on demographic data and surveys to make up for the missing data.

Spatial indexing and temporal indexing are performed respectively at steps S214 and S216. Indexing is necessary in the development of scalable models. Spatial indexing involves generating hash for location referencing, and temporal indexing involves timestamping. Depending on the temporal scale and spatial scale, the flow may need to be aggregated over: (i) period of time (e.g., peak hour, late hour operations, etc.); and (ii) location specific analysis (e.g., near a station, at a select zip code, etc.) For development of scalable systems, it is necessary to index each trajectory in order so as to decrease the time it takes to locate features that match a spatial query. Example of a query can be the number of people moving from one predefined geological area to another area.

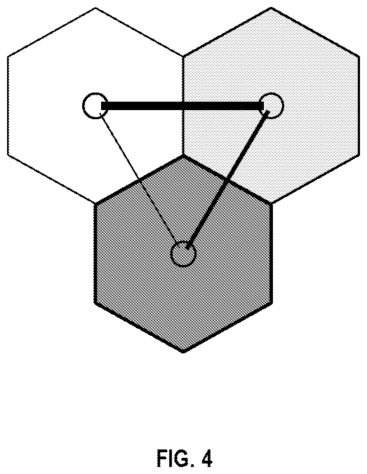

FIG. 4 illustrates an example hexagonal tessellation configuration showing movement across different regions, in accordance with an example implementation. As illustrated in FIG. 4, the color intensity in each hexagonal area shows the number of users located in each area and the potential for the users to move from one area to another. The thickness of each line that stretches across two hexagonal areas shows the number of movements between different areas.

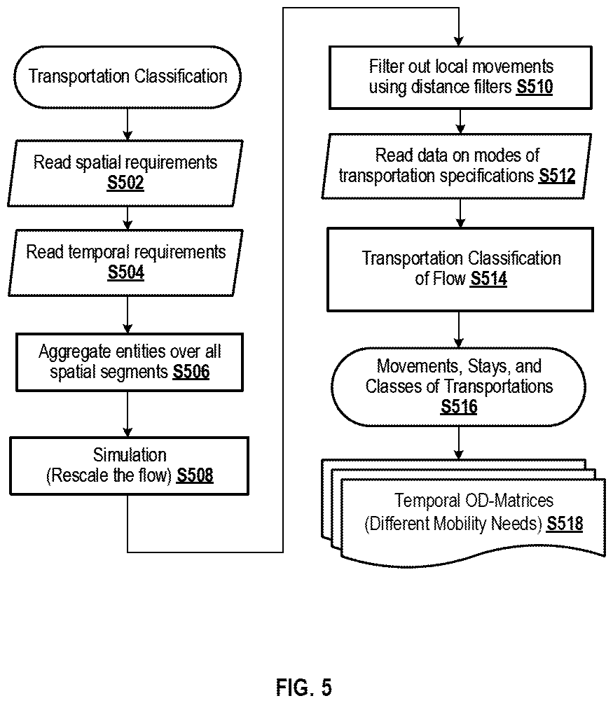

Referring back to FIG. 2, on completion of trajectory aggregation and indexing, transportation classification at step S218 is performed to extract the transportation type from the flow data. FIG. 5 illustrates an example process flow for transportation classification, in accordance with an example implementation. At steps S502 and S504, spatial requirements and temporal requirements are read to capture the flow behaviors. The spatial requirements comprise geographical constraints and the temporal requirements comprise operational time associated with transits and time flexibility.

At S506, entity aggregation is performed to aggregate the flow, whether it is moving from one segment to another or staying in the segment in the next time step. At S508, simulation is performed over aggregated flow to rescale the flow. At S510, local movements are filtered out using distance filters. The local movements comprise displacements not associated with transportations and displacements within buildings.

At S510, data is read on modes of transportation specifications to match with flow (e.g., short-range, medium range, long range transportation, etc.) At S512, the flow is mapped based on the specifications to different transportation modes to classify the different transportations. At S514, temporal graphs of flow movement between segments are generated. The generated temporal graphs represent people movement at different time period (e.g., peak hour graphs, peak to late hour transition graphs, etc.) Each time-step has a corresponding temporal graph. At S516, contexts are provided to the people flow data. For example, associating movements to station, mode of transit, wait times (passive), etc. Local movement being filtered out from total flow for segment demand prediction generation. Each time step has its own origin-destination matrix (OD matrix) and together, temporal OD matrices are generated for different mobility needs at S518.

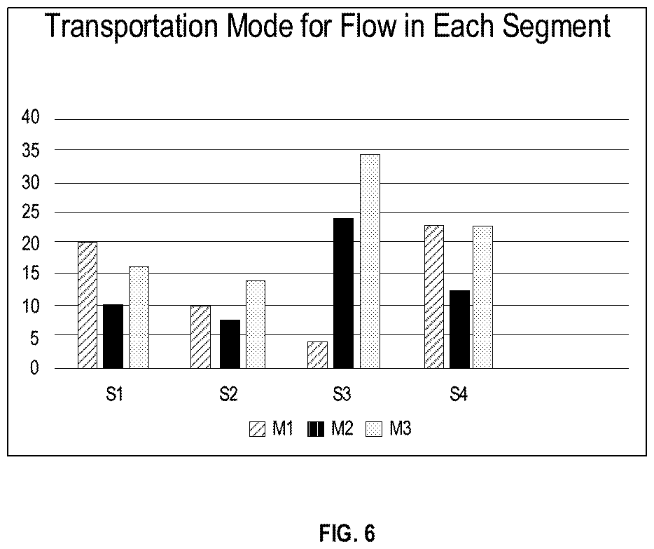

For mobile people flow data, the cleaned and smoothed people flow data then must be divided into activity, mode of transport, and trip segments. An activity is time spent at home, work, shopping, etc., and trip segments indicate travel between activities. FIG. 6 illustrates an example transportation mode flow that is divided based on segments, in accordance with an example implementation.

An activity segment may be identified by more than one method because of its time, density, signal interval features, and etc. Based on the speed and acceleration characteristics of trip, people flow data can be used to separate motorized-mode (car, bus, train) trips and nonmotorized mode (walk, bike) trips. Furthermore, it is possible to add inertial sensors to detect the activity type and modes of transportation more accurately.

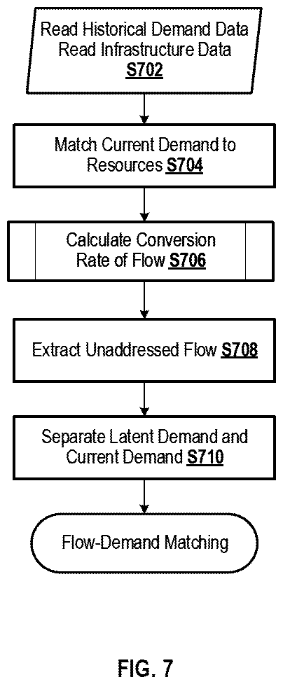

FIG. 7 illustrates an example process flow for flow-demand matching step S222 of FIG. 2, in accordance with an example implementation. The process begins at S702, where historical demand data and infrastructure data are retrieved and read. At S704, current demand is matched to resources. Resources refer to transit modes (e.g., bus, train, car, etc.) and the surrounding infrastructures (e.g., station, charging point, etc.) To match flow with the current demand, access to demand segmented for different modes of transportation is required. Access to data associated with different modes of transportation results allows for better and more accurate matching.

At S706, conversion rate of flow is calculated. Conversion rate is the ratio of realized demand to latent demand. The conversion rate of flow indicates the actual utility of the latent demand. At S708, unaddressed flow is extracted. At S710, latent demand is separated from current demand. Latent demand is total addressable demand and current demand is actual service usage. The factors that are not reflected in the current demand calculated from observing a single mode or conventional parameters are represented by latent demand, which is evaluated from observing all transit-oriented activities and signals.

Referring back to FIG. 2, on completion of step S222, the process proceeds to modal classification based on usage type (e.g., public, private, shared, rented/leased, etc.) at S224 and latent demand estimation S226. At S228, the segmented demand is analyzed to perform demand-supply matching for different modes of transportation. Accurate demand-supply estimation can be used to revisit mobility plans and redesign cities accordingly in multiple spatial and temporal scales. Transportation supplies associated with the various transportation types can be optimized based on the demand-supply estimation. In addition, transportations types best fitted for an area can be identified through the demand-supply estimation.

The foregoing example implementation may have various benefits and advantages. For example, the demand forecasting system provides comprehensive view of total demand including historical demand, demand related to emerging services and technologies, and latent demand (e.g., unseen by the system due to lack of proper planning and inaccurate supply-demand matching). The forecasting system detects transportation modes of travelers, calculates traffic flow in an area, and predicts the traffic flow at a later time in the future.

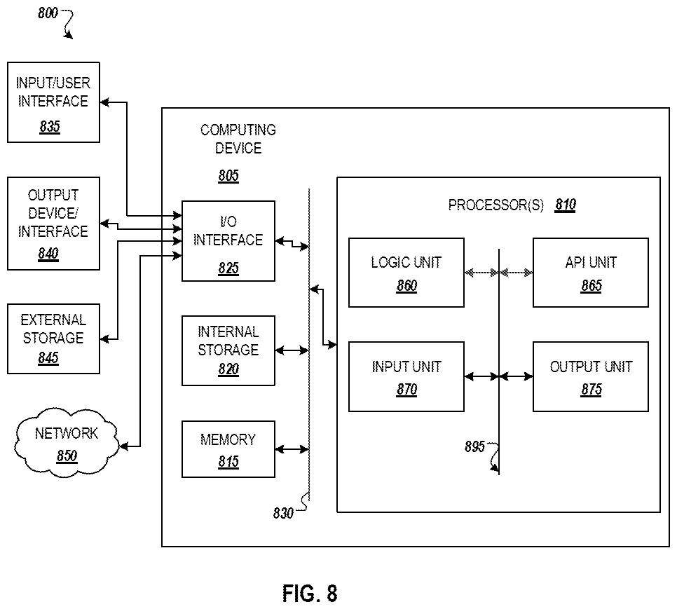

FIG. 8 illustrates an example computing environment with an example computing device suitable for use in some example implementations. Computing device 805 in computing environment 800 can include one or more processing units, cores, or processors 810, memory 815 (e.g., RAM, ROM, and/or the like), internal storage 820 (e.g., magnetic, optical, solid-state storage, and/or organic), and/or IO interface 825, any of which can be coupled on a communication mechanism or bus 830 for communicating information or embedded in the computing device 805. IO interface 825 is also configured to receive images from cameras or provide images to projectors or displays, depending on the desired implementation.

Computing device 805 can be communicatively coupled to input/user interface 835 and output device/interface 840. Either one or both of the input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 840 may include a display, television, monitor, printer, speaker, braille, or the like. In some example implementations, input/user interface 835 and output device/interface 840 can be embedded with or physically coupled to the computing device 805. In other example implementations, other computing devices may function as or provide the functions of input/user interface 835 and output device/interface 840 for a computing device 805.

Examples of computing device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 805 can be communicatively coupled (e.g., via IO interface 825) to external storage 845 and network 850 for communicating with any number of networked components, devices, and systems, including one or more computing devices of the same or different configuration. Computing device 805 or any connected computing device can be functioning as, providing services of, or referred to as a server, client, thin server, general machine, special-purpose machine, or another label.

IO interface 825 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computing device 805 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computing device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or in a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, the input unit 870, the output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide an output based on the calculations described in example implementations.

Processor(s) 810 can be configured to collect people flow data from a network of a plurality of sensors within an area of interest, wherein each sensor of the plurality of sensors is associated with a user device as illustrated in FIG. 2. The processor(s) 810 may also be configured to process the people flow data to generate movement trajectories as illustrated in FIG. 2. The processor(s) 810 may also be configured to map the movement trajectories to existing transportation network as illustrated in FIG. 2. The processor(s) 810 may also be configured to aggregate the movement trajectories associated with the network of the plurality of sensors to estimate movement flow density as illustrated in FIG. 2. The processor(s) 810 may also be configured to, for the people flow data representing less than entire population of the area of interest, perform data simulation to rescale the movement flow density as illustrated in FIG. 2. The processor(s) 810 may also be configured to classify the people flow data into different transportation types as illustrated in FIG. 2. The processor(s) 810 may also be configured to generate flow-demand matching by matching current demand with transportation resource information as illustrated in FIG. 2.

The processor(s) 810 may also be configured to perform trajectory preprocessing to the movement trajectories to compensate for global positioning system (GPS) errors and provide data smoothing to the movement trajectories as illustrated in FIG. 2. The processor(s) 810 may also be configured to generate demand-supply matching to estimate demand based on the generated flow-demand matching as illustrated in FIG. 2. The processor(s) 810 may also be configured to perform mode classification and latent demand estimation on the generated flow-demand matching to generate demand-supply matching as illustrated in FIG. 2. The processor(s) 810 may also be configured to perform map matching by mapping observed behaviors of the people flow data from the network of the plurality of sensors over edges of existing transportation network based on timestamps as illustrated in FIGS. 2-3.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for demand estimation, the method comprising:
collecting people flow data from a network of a plurality of sensors within an area of interest, wherein each sensor of the plurality of sensors is associated with a user device;
processing the people flow data to generate movement trajectories;
mapping the movement trajectories to existing transportation network;
aggregating the movement trajectories associated with the network of the plurality of sensors to estimate movement flow density;
for the people flow data representing less than entire population of the area of interest, performing data simulation to rescale the movement flow density;
classifying the people flow data into different transportation types; and
generating flow-demand matching by matching current demand with transportation resource information.

2. The method of claim 1, further comprising:
performing trajectory preprocessing to the movement trajectories to compensate for global positioning system (GPS) errors and provide data smoothing to the movement trajectories.

3. The method of claim 1, wherein the classifying the people flow data into different transportation types comprises:
reading spatial requirements, wherein the spatial requirements comprise geographical constraints;
reading temporal requirements, wherein the temporal requirements comprise operational time associated with transits and time flexibility;
aggregating the people flow data over spatial segments;
applying distance filters to filter out local movements, wherein local movements comprise displacements not associated with transportations and displacements within buildings;
reading data on modes of transportation specifications; and
classifying the people flow data into the different transportation types based on the data on modes of transportation specifications.

4. The method of claim 1, wherein the performing data simulation to rescale the movement flow density comprises:
performing spatial indexing and temporal indexing to rescale the movement flow density,
wherein the spatial indexing involves generating hash for location referencing, and
wherein the temporal indexing involves timestamping.

5. The method of claim 1, further comprising:
generating demand-supply matching to estimate demand based on the generated flow-demand matching.

6. The method of claim 5, further comprising:
performing mode classification and latent demand estimation on the generated flow-demand matching to generate demand-supply matching.

7. The method of claim 1, further comprising:
performing map matching by mapping observed behaviors of the people flow data from the network of the plurality of sensors over edges of existing transportation network based on timestamps.

8. The method of claim 1, wherein the people flow data comprises global positioning system (GPS) data.

9. A non-transitory computer readable medium, storing instructions for demand estimation, the instructions comprising:
collecting people flow data from a network of a plurality of sensors within an area of interest, wherein each sensor of the plurality of sensors is associated with a user device;
processing the people flow data to generate movement trajectories;
mapping the movement trajectories to existing transportation network;
aggregating the movement trajectories associated with the network of the plurality of sensors to estimate movement flow density;
for the people flow data representing less than entire population of the area of interest, performing data simulation to rescale the movement flow density;
classifying the people flow data into different transportation types; and
generating flow-demand matching by matching current demand with transportation resource information.

10. The non-transitory computer readable medium of claim 9, further comprising:
performing trajectory preprocessing to the movement trajectories to compensate for global positioning system (GPS) errors and provide data smoothing to the movement trajectories.

11. The non-transitory computer readable medium of claim 9, wherein the classifying the people flow data into different transportation types comprises:
reading spatial requirements, wherein the spatial requirements comprise geographical constraints;
reading temporal requirements, wherein the temporal requirements comprise operational time associated with transits and time flexibility;
aggregating the people flow data over spatial segments;
applying distance filters to filter out local movements, wherein local movements comprise displacements not associated with transportations and displacements within buildings;
reading data on modes of transportation specifications; and
classifying the people flow data into the different transportation types based on the data on modes of transportation specifications.

12. The non-transitory computer readable medium of claim 9, wherein the performing data simulation to rescale the movement flow density comprises:
performing spatial indexing and temporal indexing to rescale the movement flow density,
wherein the spatial indexing involves generating hash for location referencing, and
wherein the temporal indexing involves timestamping.

13. The non-transitory computer readable medium of claim 9, further comprising:
generating demand-supply matching to estimate demand based on the generated flow-demand matching.

14. The non-transitory computer readable medium of claim 13, further comprising:
performing mode classification and latent demand estimation on the generated flow-demand matching to generate demand-supply matching.

15. The non-transitory computer readable medium of claim 9, further comprising:
performing map matching by mapping observed behaviors of the people flow data from the network of the plurality of sensors over edges of existing transportation network based on timestamps.

16. The non-transitory computer readable medium of claim 9, wherein the people flow data comprises global positioning system (GPS) data.
